(19) United States
(12) Patent Application Publication
(10) Pub. No.: US 2013/0002950 A1
(43) Pub. Date: Jan. 3, 2013

(54) Methods and Systems for Transport Stream Time Base Correction

(76) Inventor: Ken Thompson, Dunwoody, GA (US)

(21) Appl. No.: 12/441,563

(22) PCT Filed: Sep. 21, 2007
(86) PCT No.: PCT/US2007/079238

§ 371 Date: Nov. 16, 2009

Related U.S. Application Data
(60) Provisional application No. 60/826,696, filed on Sep. 22, 2006.

(51) Int. Cl. H04N 5/04

(52) U.S. Cl. 348/500; 348/E05.009

(57) ABSTRACT

Provided are methods and systems for correcting decoder artifacts.

### CROSS REFERENCE TO RELATED PATENT APPLICATION

This application claims priority to U.S. Provisional Application No. 60/826,696 filed Sep. 22, 2006, herein incorporated by reference in its entirety.

### SUMMARY

Provided are methods and systems for correcting decoder artifacts comprising receiving a stream previously stamped with an incoming Presentation Time Stamp (PTS)/Decode Time Stamp (DTS), re-stamping the incoming PTS/DTS with a predetermined value, applying a time base corrector, and providing the stream to a set-top box for display. Additional advantages will be set forth in part in the description which follows or may be learned by practice. The advantages will be realized and attained by means of the elements and combinations particularly pointed out in the appended claims. It is to be understood that both the foregoing general description and the following detailed description are exemplary and explanatory only and are not restrictive, as claimed.

### BRIEF DESCRIPTION OF THE DRAWINGS

The accompanying drawings, which are incorporated in and constitute a part of this specification, illustrate embodiments and together with the description, serve to explain the principles of the methods and systems:

FIG. 1 illustrates various aspects of an exemplary system in which the present invention can operate;

FIG. 2 shows that one video PES and a number of audio PES can be combined to form a program stream;

FIG. 3 illustrates exemplary header contents;

FIG. 4 illustrates that when an access unit containing an I-picture is received, it can have both DTS and PTS in the header;

FIG. 5 illustrates clocks in an exemplary video system;

FIG. 6 illustrates an exemplary architecture for transport stream time base correction;

FIG. 7 illustrates an exemplary method for correcting decoder artifacts; and

FIG. 8 shows a sequence of pictures as they would be displayed before and after field repetition is applied.

### DETAILED DESCRIPTION

Before the present methods and systems are disclosed and described, it is to be understood that the methods and systems are not limited to specific synthetic methods, specific components, or to particular compositions, as such may, of course, vary. It is also to be understood that the terminology used herein is for the purpose of describing particular embodiments only and is not intended to be limiting.

As used in the specification and the appended claims, the singular forms “a,” “an” and “the” include plural referents unless the context clearly dictates otherwise. Ranges may be expressed herein as from “about” one particular value, and/or to “about” another particular value. When such a range is expressed, another embodiment includes from the one particular value and/or to the other particular value. Similarly, when values are expressed as approximations, by use of the antecedent “about,” it will be understood that the particular value forms another embodiment. It will be further understood that the endpoints of each of the ranges are significant both in relation to the other endpoint, and independently of the other endpoint.

“Optional” or “optionally” means that the subsequently described event or circumstance may or may not occur, and that the description includes instances where said event or circumstance occurs and instances where it does not.

The present methods and systems may be understood more readily by reference to the following detailed description of preferred embodiments and the Examples included therein and to the Figures and their previous and following description.

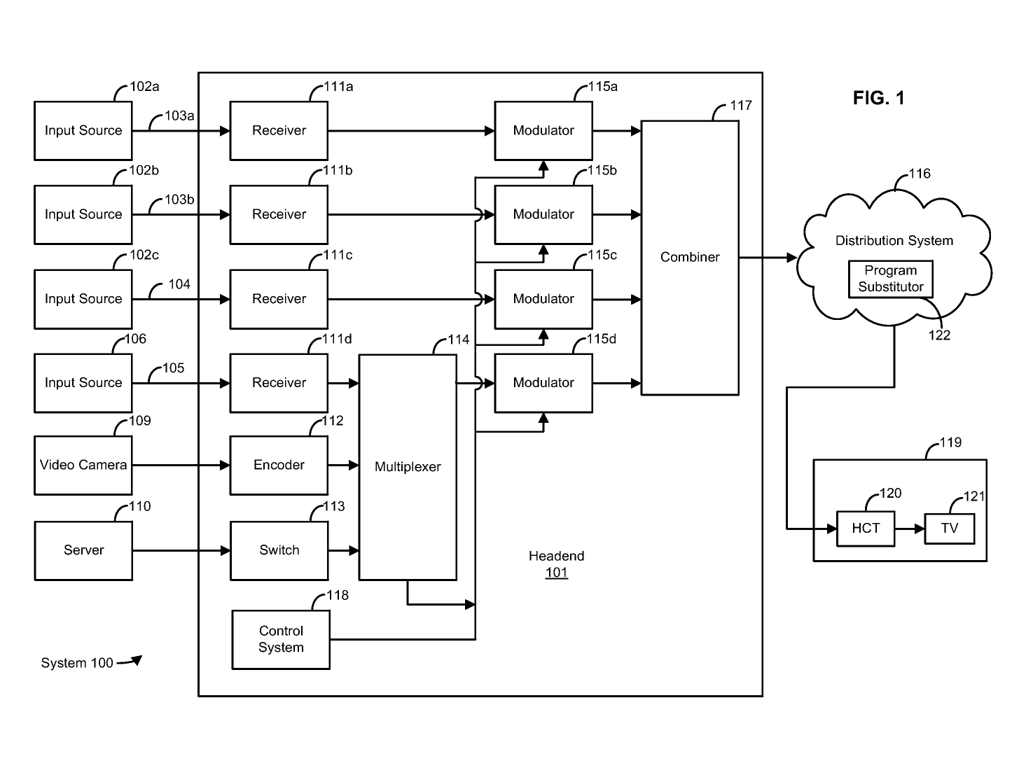

FIG. 1 illustrates various aspects of an exemplary system in which the present invention can operate. Those skilled in the art will appreciate that present invention may be used in systems that employ both digital and analog equipment.

The system 100 includes a headend 101, which receives input programming from multiple input sources. The headend 101 combines the programming from the various sources and distributes the programming to subscriber locations (e.g., subscriber location 119) via distribution system 116. In one aspect, the distribution system 116 can be an RF network, the Internet, or combinations thereof.

In a typical system, the headend 101 receives programming from a variety of sources 102a, 102b, 102c. The programming signals may be transmitted from the source to the head end 101 via a variety of transmission paths, including satellite 103a, 103b, and terrestrial broadcast 104. The headend 101 can also receive programming from a direct feed source 106 via a direct line 105. Other input sources include a video camera 109 or a server 110. The signals provided by the programming sources can include a single program or a multiplex that includes several programs.

The headend 101 includes a plurality of receivers 111a, 111b, 111c, 111d that are each associated with an input source. MPEG encoders such as encoder 112, are included for encoding such things as local programming or a video camera 109 feed. A switch 113 provides access to server 110, which can be a Pay-Per-View server, a data server, an internet router, a network system, or a phone system. Some of the signals may require additional processing, such as signal multiplexing prior to being modulated. Such multiplexing can be done by multiplexer (mux) 114.

The headend 101 contains a plurality of modulators, 115a, 115b, 115c, and 115d, for interfacing to the distribution system 116. The modulators convert the received programming information into a modulated output signal suitable for transmission over the distribution system 116. The modulators, 115a, 115b, 115c, and 115d can be configured for modulating the processed encoded signal to a modulated signal and for providing the modulated signal to an upconverter. The modulated signal can be, for example, a QAM signal, a QPSK signal, or a VSB signal. The modulators, 115a, 115b, 115c, and 115d can upconvert a signal. Alternatively the modulators 115a, 115b, 115c, and 115d can each be coupled to a separate up converter (not shown). The up converter can be configured for shifting frequency content of the modulated signal to an available portion of RF spectrum. The available portion can have been previously unused in the original RF feed, or it can be eliminated with a deletion filter. The input to the modulators is usually at a fixed intermediate frequency (i.e., 45 MHz). The upconverter moves the modulated signal to a new frequency (i.e., 561 MHz for channel 80). Each upconverter can be set to a different target frequency to create the complete channel lineup. Without agile upconversion, the head-end could only transmit one channel.

The output signals from the modulators are combined, using equipment such as a combiner 117, for input into the distribution system 116.

A control system 118 allows the television system operator to control and monitor the functions and performance of the television system 100. The control system 118 interfaces, monitors, and/or controls a variety of functions, including the channel lineup for the television system, billing for each subscriber, and conditional access for programming distributed to subscribers. Control system 118 provides input to the modulators for setting their operating parameters, such as system specific MPEG table packet organization or conditional access information. The control system 118 can be located at headend 101 or remotely.

The distribution system 116 distributes signals from the headend 101 to subscriber locations, such as subscriber location 119. The distribution system 116 can be an optical fiber network, a coaxial cable network, a hybrid fiber-coaxial network, a satellite system, or a direct broadcast system. Program substitutor 122 can be located within the distribution system 116 at any point between the headend 101 and the subscriber location 119 (such as an MDU). By way of example, the program substitutor 122 can be located in close proximity to subscriber location 119. There is a multitude of subscriber locations connected to distribution system 116. At subscriber location 119, a decoder 120, such as a home communications terminal (HCT) decodes the signals for display on a display device, such as on a television set (TV) 121 or a computer monitor. Those skilled in the art will appreciate that the signal can be decoded in a variety of equipment, including an HCT, a computer, a TV, a monitor, or satellite dish.

In an exemplary embodiment, the present invention can be applied anywhere that the digital stream is available after it is created by an encoder. For example, the multiplexer in the headend, a program substitutor, and the like.

The Moving Pictures Experts Group (MPEG) was established by the

International Standards Organization (ISO) for the purpose of creating standards for digital audio/video compression. The MPEG experts created the MPEG-1 and MPEG-2 standards, with the MPEG-1 standard being a subset of the MPEG-2 standard. The combined MPEG-1 and MPEG-2 standards are hereinafter referred to as MPEG. In an MPEG encoded transmission, programming and other data are transmitted in packets, which collectively make up a transport stream. Additional information regarding transport stream packets, the composition of the transport stream, types of MPEG tables, and other aspects of the MPEG standards are described below. In an exemplary embodiment, the present invention employs MPEG packets. However, the present invention is not so limited, and can be implemented using other types of data.

The output of a single MPEG audio or video coder is called an elementary stream. An elementary stream is an endless near real-time signal. For convenience, the elementary stream may be broken into data blocks of manageable size, forming a packetized elementary stream (PES). These data blocks need header information to identify the start of the packets and must include time stamps because packetizing disrupts the time axis.

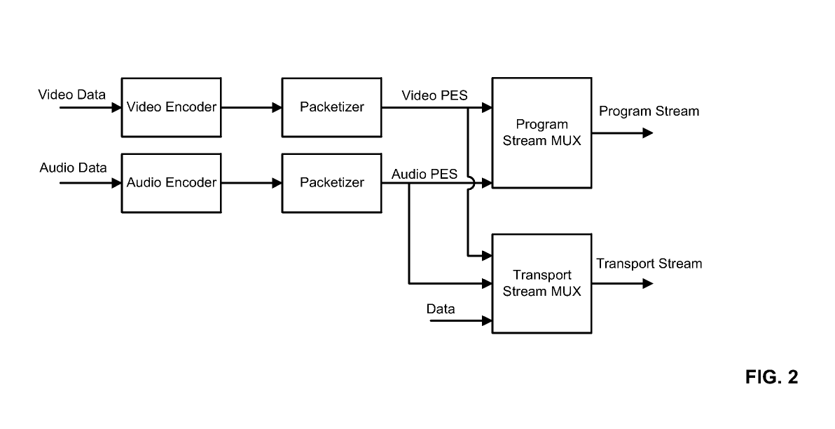

FIG. 2 shows that one video PES and a number of audio PES can be combined to form a program stream, provided that the coders are locked to a common clock. Time stamps in each PES can be used to ensure lip-sync between the video and audio. Program streams can have variable-length packets with headers. They find use, for example, in data transfers to and from optical and hard disks, which are essentially error free, and in which files of arbitrary sizes are expected. DVD uses program streams.

For transmission and digital broadcasting, several programs and their associated PESs can be multiplexed into a transport stream (single program or multi-program). As used herein, transport stream can refer to either a single program transport stream, a multi-program transport stream, or both. A transport stream can have a program clock reference (PCR) mechanism that allows transmission of multiple clocks, one of which can be selected and regenerated at the decoder.

A transport stream is more than just a multiplex of audio and video PESs. In addition to the compressed audio, video and data, a transport stream can comprise metadata describing the bit stream. This can comprise a program association table (PAT) that lists every program in the multi program transport stream. Each entry in the PAT points to a program map table (PMT) that lists the elementary streams making up each program. Some programs will be open, but some programs may be subject to conditional access (encryption) and this information is also carried in the metadata. The transport stream can comprise fixed-size data packets, each containing, for example, 188 bytes. Each packet can carry a program identifier code (PID). Packets in the same elementary stream can have the same PID, so that the decoder (or a demultiplexer) can select the elementary stream(s) it wants and reject the remainder. Packet continuity counts ensure that every packet that is needed to decode a stream is received. A synchronization system can be used so that decoders can correctly identify the beginning of each packet and deserialize the bit stream into words.

A program is a group of one or more PIDs that are related to each other. For instance, a transport stream used in digital television might contain three programs, to represent three television channels. Suppose each channel comprises of one video stream, one or two audio streams, and any necessary metadata. A receiver wishing to tune to a particular “channel” merely has to decode the payload of the PIDs associated with its program. It can discard the contents of all other PIDs.

The transport stream can carry many different programs and each may use a different compression factor and a bit rate that can change dynamically even though the overall bit rate stays constant. This behavior is called statistical multiplexing and it allows a program that is handling difficult material to borrow bandwidth from a program handling easy material. Each video PES can have a different number of audio and data PESs associated with it. Despite this flexibility, a decoder must be able to change from one program to the next and correctly select the appropriate audio and data channels. Some of the programs can be protected so that they can only be viewed by those who have paid a subscription or fee. The transport stream can comprise Conditional Access (CA) information to administer this protection. The transport stream can comprise Program Specific Information (PSI) to handle these tasks.

The transport layer converts the PES data into small packets of constant size (adding stuffing bits if necessary) that are self-contained. When these packets arrive at the decoder, there may be jitter in the timing. The use of time division multiplexing also causes delay, but this factor is not fixed because the proportion of the bit stream allocated to each program need not be fixed. Time stamps can be part of the solution and are effective if a stable clock is available. The transport stream can comprise further data allowing the re-creation of a stable clock. The operation of digital video production equipment is heavily dependent on the distribution of a stable system clock for synchronization. In video production, genlocking is used, but over long distances, the distribution of a separate clock is not practical. In a transport stream, the different programs may have originated in different places that are not necessarily synchronized. As a result, the transport stream has to provide a separate means of synchronizing for each program.

This additional synchronization method can be referred to as Program Clock Reference (PCR) and it recreates a stable reference clock that can be divided down to create a time line at the decoder, so that the time stamps for the elementary streams in each program become useful. Consequently, one definition of a program is a set of elementary streams sharing the same timing reference.

A transport stream can comprise one or more PCR channels that recreate a program clock for both audio and video. The transport stream is often used as the communication between an audio/video coder and a multiplexer.

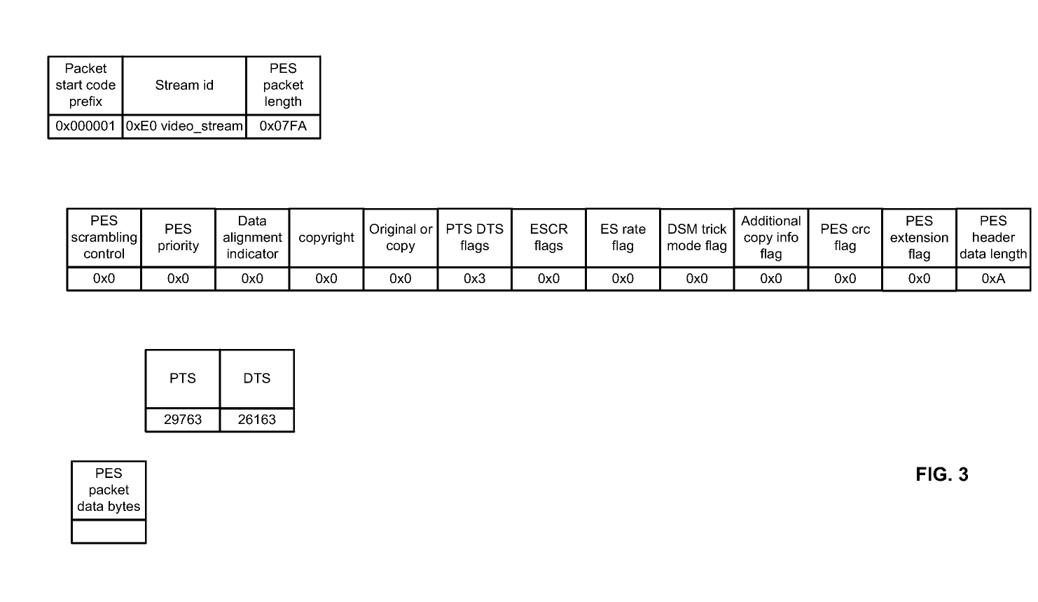

In the PES, an endless elementary stream can be divided into packets of a convenient size for the application. This size can be, for example, a few hundred kilobytes, although this can vary with the application. Each packet can be preceded by a PES packet header. FIG. 3 illustrates exemplary header contents. The packet can begin, for example, with a start-code prefix of 24 bits and a stream ID that identifies the contents of the packet as video or audio and further specifies the type of audio coding. These two parameters (start code prefix and stream ID) can comprise the packet start code that identifies the beginning of a packet.

Since MPEG defines the transport stream, not the encoder, a multiplexer can be used that converts from elementary streams to a transport stream in one step. In this case, the PES packets may never exist in an identifiable form, but instead, they can be logically present in the transport stream payload.

After compression, pictures are sent out of sequence because of bidirectional coding. They can require a variable amount of data and can be subject to variable delay due to multiplexing and transmission. In order to keep the audio and video locked together, time stamps can be periodically incorporated in each picture. A time stamp can be, for example, a 33-bit number that is a sample of a counter driven by a 90-kHz clock. This clock can be obtained by dividing a 27-MHz program clock by 300. In some aspects, presentation times are evenly spaced, thus it is not essential to include a time stamp in every presentation unit. Instead, time stamps can be interpolated by the decoder.

Time stamps can indicate where a particular access unit belongs in time. Lip sync can be obtained by incorporating time stamps into the headers in both video and audio PES packets. When a decoder receives a selected PES packet, it can decode each access unit and buffer it into RAM. When the time-line count reaches the value of the time stamp, the RAM can be read out. This operation can achieve effective time base correction in each elementary stream and the video and audio elementary streams can be synchronized together to make a program.

When bidirectional coding is used, a picture may have to be decoded some time before it is presented so that it can act as the source of data for a B-picture. Although pictures can be presented, for example, in the order IBBP, they can be transmitted in the order IPBB. Consequently, two types of time stamps can be used. A decode time stamp (DTS) indicates the time when a picture must be decoded, whereas a presentation time stamp (PTS) indicates when it must be presented to the decoder output.

B-pictures can be decoded and presented simultaneously so that they only contain PTS. When an IPBB sequence is received, both I- and P-can be decoded before the first B-picture. In some aspects, a decoder can only decode one picture at a time; therefore the I-picture can be decoded first and stored. While the P-picture is being decoded, the decoded I-picture can be output so that it can be followed by the B-pictures.

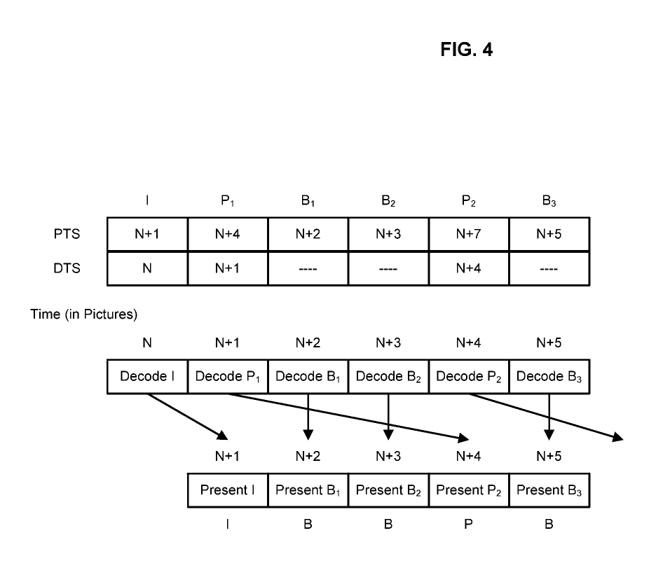

FIG. 4 illustrates that when an access unit containing an I-picture is received, it can have both DTS and PTS in the header and these time stamps can be separated by one picture period. If bidirectional coding is used, a P-picture can follow and this picture can also have a DTS and a PTS time stamp, but the separation between the two stamp times is three picture periods to allow for the intervening B-pictures. Thus, if IPBB is received, I can be delayed one picture period, P can be delayed three picture periods, the two Bs are not delayed at all, and the presentation sequence becomes IBBP. Clearly, if the Group of Pictures (GOP) structure is changed such that there are more B-pictures between I and P, the difference between DTS and PTS in the P-pictures can be greater.

The PTS/DTS flags in the packet header can be set to indicate the presence of PTS alone or both PTS and DTS time stamp. Audio packets can comprise several access units and the packet header can comprise a PTS. Because audio packets are typically never transmitted out of sequence, there is usually no DTS in an audio packet.

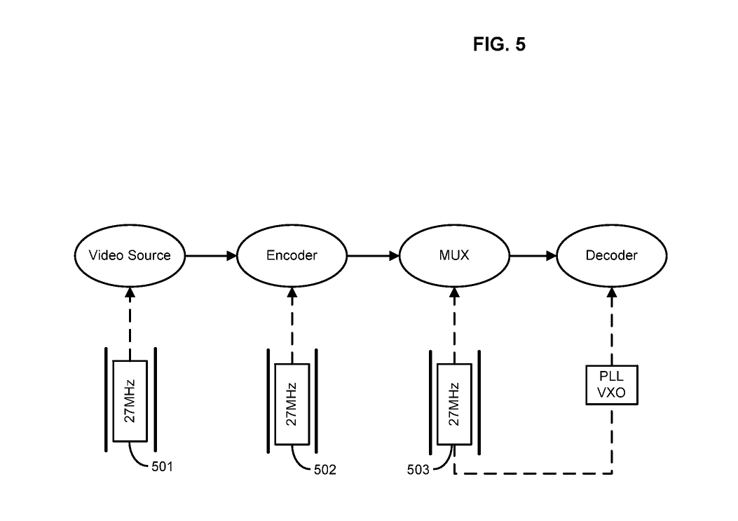

FIG. 5 illustrates clocks in an exemplary video system. In one aspect, clocks associated with the system can comprise a Video Source clock 501 and an Encoder clock 502. The Video Source clock 501 sets the rate at which video frames are generated, and the Encoder clock 502 establishes the timestamps (for example, timestamps can be 90 KHz counters derived from a 27 MHz clock) applied to encoded video. Both clocks can be free-running and can operate at slightly different rates. It can be assumed that the Encoder clock 502 and a MUX clock 503 are effectively locked.

Traditional systems use time base correctors to adjust video frame rates to compensate for variations between clocks, and the associated frame rates. Such time base correctors can adjust video frame rates to compensate for variations between clocks, and the associated frame rates. Traditional systems adjust the video stream when the clock drifts exceed a frame, either by dropping frame or repeating fields in two adjacent frames. The former addresses situations where frames arrive fast (relative to a given clock) and the latter when the frames arrive slow.

PVR encoders (and other commodity encoding technologies) do not typically implement a traditional frame drop, field repeat Time Base Correction (TBC). In these systems, as previously discussed, an encoder timestamps incoming frames with its independent clock that is not synchronized with the video source. This results in Presentation and Decode Time Stamps (PTS/DTS) values that may not differ by exact multiples of 3003. Faster sources can be stamped with slightly shorter spacings and slower sources with slightly longer spacings. PCRs can be generated from the same, independent clock, so the clock recovered by the decoder is the encoder clock, consistent with these timestamps. This guarantees that frames are displayed at the same rate received, avoiding decoder buffering problems.

This appears to cause no problem with most decoders and Set Top Boxes (STBs). However, this can create analyzer errors and can be incompatible with some STBs. The effect is an unacceptable video disruption occurring, for example, between 2 and 5 times per minute, depending on clock rate differences. Elements affecting Transport Stream Time Base Correction include, but are not limited to, the MUX requirement for a properly formed Constant Bit Rate (CBR) SPTS and the decoder operating at the encoder clock rate rather than the source.

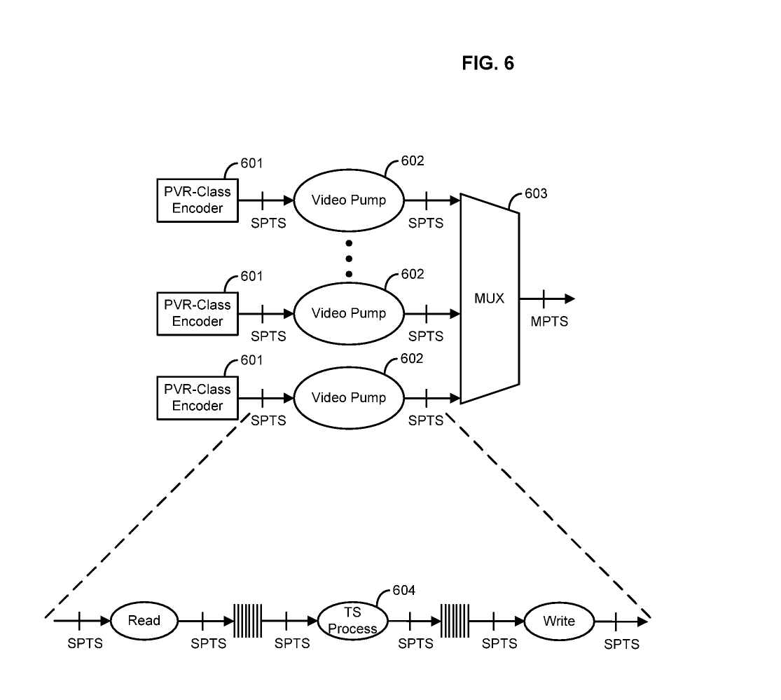

In one aspect, illustrated in FIG. 6, provided is an exemplary architecture for transport stream time base correction. One or more PVR-Class Encoders 601 can provide a single program transport stream (SPTC) to one or more Video Pumps 602. The Video Pumps 602 can provide a connection between the encoder 601 and a MUX 603. Video Pumps 602 can buffer data to prevent over/underflows and perform any necessary transforms on the encoder SPTS. The currently used transforms can comprise quad-byte alignment, TBC, PID remapping, and removing undesirable packets such as PATs with undesirable metadata. The Video Pumps 602 can provide a processed SPTS to the MUX 603 which can output a multiple-program transport stream MPTS.

In an aspect, the time base correction methods provided can be incorporated into a Transport Stream (TS) Processing component 604 of the Video Pump 602. An incoming stream can be an SPTS comprising one or more of, PAT, PMT, video, audio and PCR elementary streams. Stream processing can comprise acquiring and maintaining transport buffer synchronization and parsing PAT and PMT to identify video, audio and PCR Pills. Data from the encoder can be read in arbitrary chunks and the stream processor can guarantee that downstream writes begin and end on transport stream packet boundaries and are sized to optimize performance.

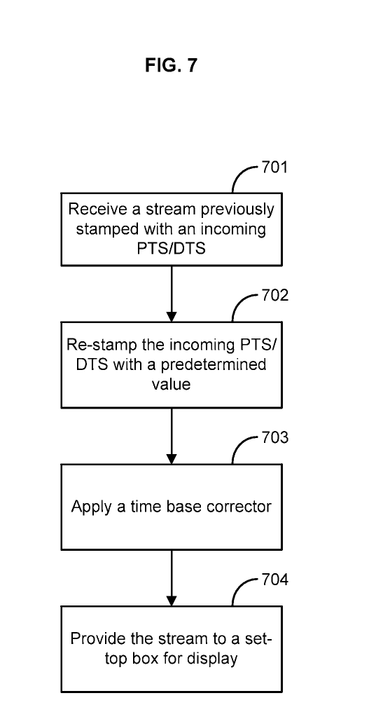

In another aspect, illustrated in FIG. 7, provided are methods for correcting decoder artifacts comprising receiving a stream previously stamped with an incoming PTS/DTS at 701, re-stamping the incoming PTS/DTS with a predetermined value at 702, applying a time base corrector at 703, and providing the stream to a set-top box for display at 704.

The re-stamped PTS and the re-stamped DTS can be a predetermined value apart and a predetermined modulo. The predetermined value apart is a function of a GOP structure. In one aspect, the predetermined value apart can be equal to the UP frame spacing. For the 15:3 GOP, this can be three frames, or 9009. For a GOP with four frames per I or P frame, the predetermined value apart can be 4 frames, or 12012. The predetermined value apart can be, for example, a proper multiple of 3003. 9009 is an exemplary multiple that fits for a 15:3 GOP. The predetermined modulo can be, for example, 3003.

Applying the time base corrector can comprise determining a difference between the incoming PTS/DTS and the re-stamped PTS/DTS and re-syncing the re-stamped PTS/DTS to the incoming PTS/DTS, respectively, when the difference exceeds a predetermined frame-time. The step of re-syncing can be performed on a B frame. An exemplary predetermined frame-time difference for resync can be one frame, or 3003.

The time base corrector can compensate for drift between the incoming PTS/DTS and the re-stamped PTS/DTS. The time base corrector can re-stamp every PTS to be exactly 3003 apart. If, for example, every incoming PTS was only 3002 apart, then the output PTS would get larger and larger in comparison to the input PTS. Eventually, the time difference between the MPEG data and the presentation time would be great enough to cause an overflow in the decoder buffers. As a result, the re-stamped PTSs can be prevented from drifting too far from the original input PTS.

The time base corrector can shift the incoming PTS/DTS by a multiple of a frame-time to cause a decoder to drop or repeat a frame.

The time base corrector can manipulate field repetition bits to repeat individual fields. Manipulating field repetition bits to repeat individual fields can comprise adding a field in consecutive B frames wherein the field compensates for PTS/DTS drift.

Providing the stream to a set-top box for display can comprise modulating to a QAM and adding to an RF network. The stream can be passed to a multiplexer that can combine the stream with other streams gathered from local and upstream sources, as well as with any necessary in-band PSI data. The resulting MPTS can be fed to a digital modulator to convert the data to the RF domain. The RF signal can be upconverted to an available frequency within the network (possibly made available with a local notch filter), and can be inserted in the RF feed with an RF combiner.

In one aspect, provided are methods for correcting decoder artifacts arising from abnormally spaced PTS/DTSs by re-stamping the PTS/DTS values with a normal spacing and applying a time base corrector to compensate for the drift between the original and re-stamped values. The time base corrector can shift the PTS/DTS by a multiple of the frame-time to cause the decoder to drop or repeat a frame. Alternatively, the time base corrector can manipulate field repetition bits to repeat individual fields. This method can address unacceptable artifacts associated with slow sources by adding fields to compensate for PTS/DTS drift. The methods provided can utilize field repetition in consecutive B frames to insert an additional frame.

Accordingly, data is neither added nor removed from the SPTS, keeping all stream timing the same. All modifications can be performed within I S or PES headers, drastically reducing any overhead from deep processing of the encoded data.

In one aspect, the time base correction methods provided can re-stamp the PTS/DTS, guaranteeing they are the proper multiple of 3003 apart and are always modulo 3003. This can eliminate an STB artifact caused by encoder PTS/DTS stamping. Over a moderate period of time audio/video sync is lost and over an extended period of time the decoder buffer underflows or overflows. To compensate for these problems, the synthetic PTS/DTS can be resynced to the incoming PTS/DTS when the difference between these two exceeds a frame-time. The resync can be guaranteed to happen on a B frame so there are no multi-frame artifacts associated with the loss of a reference frame.

The methods can be used with sources that are both faster and slower than the encoder clock. In cases with a relatively fast source clock, the decoder receives a frame time-stamped for presentation in the past and correctly discards the frame. There is no noticeable video artifact upon resync and the rate of resync is two orders of magnitude less frequent than the original artifact. in cases with a relatively slow source clock, resyncing stamps a frame for presentation two frames in the future (rather than just one) relying on the decoder to hold the previous frame for an extended time. There is no noticeable video artifact upon resync. There are no audio/video sync problems noticeable in one frame of drift and no decoder buffer underflows or overflows.

Constraints can be requirements in the encoded stream for the described methods to be used. If the original encoder does not use these parameters then the application of the field repetition method will not have the desired effect on the display sequence. Exemplary constraints can comprise,
1. progressive_sequence must be zero (0).
2. frame_pred_frame_dct must be one (1)—frame-DCT and frame prediction.
3. progressive_frame must be one (1)—fields are from same time instant.
4. picture_structure must be binary ‘11’—Frame Picture.

In one aspect, processing can be applied to two consecutive B frames further constraining to a GOP format with 2 (or more) B frames. In an aspect, 15:3 can suffice. This is not strictly a ratio, but is a MPEG-defined GOP structure indicating that an I frame will appear every 15^{th} frame and a P frame will appear every 3^{rd} frame. The insertion can be controlled by altering the top_field_first and repeat_first_field values in the Picture Coding Extension. The preceding variables can be as defined in ISO/IEC 13818-1:2000 Information technology—Generic coding of moving pictures and associated audio information: Systems and ISO/IEC 13818-2:2000(E) Information technology—Generic coding of moving pictures and associated audio information: Video, both of which are herein incorporated by reference in their entireties.

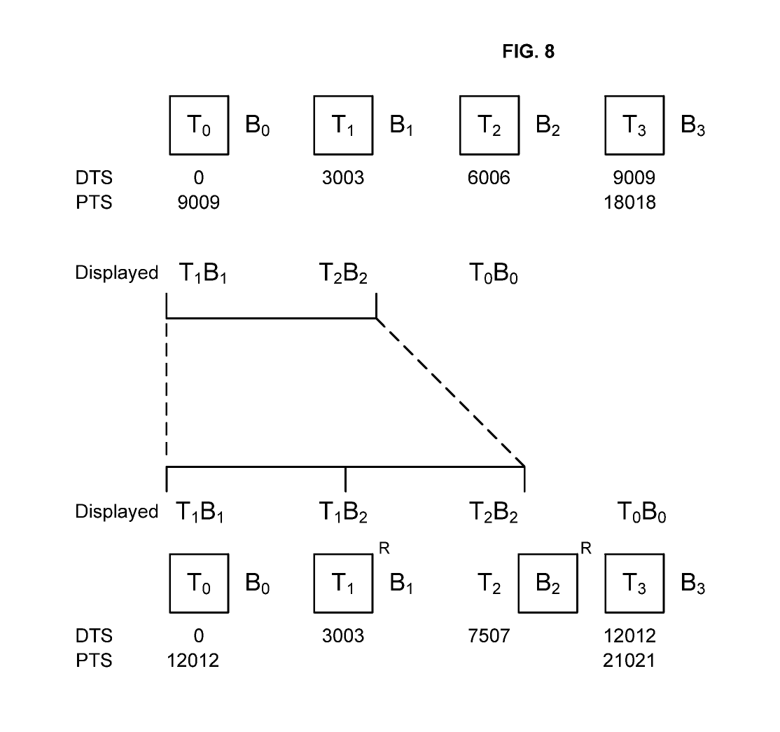

FIG. 8 shows a normal sequence and a field repetition frame insertion sequence. In the frame insertion sequence, the PTS of the initial reference frame, T₀B₀, is 3003 greater than the PTS of the same frame in the unaltered sequence due to the repetition of two fields (T₁ B₂)that produce an intermediate frame. With a repeated field, each of the B frames has a Presentation Duration of 1-½ frame time. The association of T₁B₂ as a frame is confusing but presented in this fashion for clarity. The DTS of the second B frame in the insertion sequence is offset by ½ of a frame time (1501). In one aspect, the DTS of a B frame can be the PTS. In addition to these changes, the resync mechanism can account for ongoing error to avoid long term accumulated errors. FIG. 8 shows a sequence of pictures as they would be displayed before and after field repetition is applied. The Tₙ and Bₙ represent the top and bottom field of each frame, respectively. The T or B with a surrounding box indicates which field is displayed first (via the top_field_firstbit). An ‘R’ superscript indicates that the repeat_first_field bit is set for that frame. The PTS and DTS rows indicate the relative PTS and DTS values that would be stamped on each frame. In the original (top) sequence, each frame is spaced by 3003, no fields are repeated, and the top field is always first. In the modified (bottom) sequence, T₁B₁ and T₂B₂ have the repeat_first_fieldbit set, and T₂B₂ has the top_field_first bit unset. The result is that the new T₁ B₁ frame is displayed by the decoder as T₁B₁T₁, taking 1.5 times as long. The T₂B₂ frame is displayed by the decoder as B₂T₂B₂, also taking 1.5 times as long. The net result is that a full frame of delay is added to the sequence, causing T₀B₀ to be displayed 3003 later. This modification can be applied in combination with the PTS/DTS re-stamping to perform a less objectionable resync than merely repeating frames.

While the methods and systems have been described in connection with preferred embodiments and specific examples, it is not intended that the scope be limited to the particular embodiments set forth, as the embodiments herein are intended in all respects to be illustrative rather than restrictive.

Unless otherwise expressly stated, it is in no way intended that any method set forth herein be construed as requiring that its steps be performed in a specific order. Accordingly, where a method claim does not actually recite an order to he followed by its steps or it is not otherwise specifically stated in the claims or descriptions that the steps are to be limited to a specific order, it is no way intended that an order be inferred, in any respect. This holds for any possible non-express basis for interpretation, including: matters of logic with respect to arrangement of steps or operational flow; plain meaning derived from grammatical organization or punctuation; the number or type of embodiments described in the specification.

Throughout this application, various publications are referenced. The disclosures of these publications in their entireties are hereby incorporated by reference into this application in order to more fully describe the state of the art to which the methods and systems pertain.

It will be apparent to those skilled in the art that various modifications and variations can be made without departing from the scope or spirit. Other embodiments will be apparent to those skilled in the art from consideration of the specification and practice disclosed herein. It is intended that the specification and examples be considered as exemplary only, with a true scope and spirit being indicated by the following claims.

What is claimed is:

1. A method for correcting decoder artifacts comprising:
receiving a stream previously stamped with an incoming Presentation Time Stamp (PTS)/Decode Time Stamp (DTS);
re-stamping the incoming PTS/DTS with a predetermined value;
applying a time base corrector; and
providing the stream to a set-top box for display.

2. The method of claim 1, wherein the re-stamped PTS and the re-stamped DTS are a predetermined value apart and a predetermined modulo.

3. The method of claim 2, wherein the predetermined value apart is a proper multiple of 3003.

4. The method of claim 2, wherein the predetermined value apart is a function of a Group of Pictures (GOP) structure.

5. The method of claim 2, wherein the predetermined modulo is 3003.

6. The method of claim 1, wherein applying the time base corrector comprises:
determining a difference between the incoming PTS/DTS and the re-stamped PTS/DTS; and
re-syncing the re-stamped PTS/DTS to the incoming PTS/DTS, respectively, when the difference exceeds a predetermined frame-time.

7. The method of claim 6, wherein the step of re-syncing is performed on a B frame.

8. The method of claim 6, wherein the predetermined frame-time difference for re-syncing is one frame.

9. The method of claim 1, wherein the time base corrector compensates for drift between the incoming PTS/DTS and the re-stamped PTS/DTS.

10. The method of claim 1, wherein the time base corrector shifts the incoming PTS/DTS by a multiple of a frame-time to cause a decoder to drop or repeat a frame.

11. The method of claim 1, wherein the time base corrector manipulates field repetition bits to repeat individual fields.

12. The method of claim 11, wherein manipulating field repetition bits to repeat individual fields comprises adding a field in consecutive B frames wherein the field compensates for PTS/DTS drift.

13. The method of claim 1, wherein providing the stream to a set-top box for display comprises modulating to a QAM and adding to an RF network.

14. A system for correcting decoder artifacts comprising:
an encoder, configured for encoding a signal;
a video pump, coupled to the encoder, configured for receiving the encoded signal, wherein the video pump is further configured for
receiving a stream previously stamped with an incoming Presentation Time Stamp (PTS)/Decode Time Stamp (DTS),
re-stamping the incoming PTS/DTS with a predetermined value, and
applying a time base corrector, resulting in a processed encoded signal; and
a multiplexer, coupled to the video pump, configured to receive the processed encoded signal from the video pump.

15. The system of claim 14, further comprising a decoder configured to receive the processed encoded signal and decode the processed encoded signal.

16. The system of claim 14, further comprising a modulator, coupled to the multiplexer, configured for modulating the processed encoded signal to a modulated signal and for providing the modulated signal to an upconverter.

17. The system of claim 16, wherein the upconverter is configured for shifting a frequency content of the modulated signal to an available portion of RF spectrum.

18. The system of claim 14, wherein the re-stamped PTS and the re-stamped DTS are a predetermined value apart and a predetermined modulo.

19. The system of claim 14, wherein applying the time base corrector comprises:
determining a difference between the incoming PTS/DTS and the re-stamped PTS/DTS; and
re-syncing the re-stamped PTS/DTS to the incoming PTS/DTS, respectively, when the difference exceeds a predetermined frame-time.

20. The system of claim 19, wherein the predetermined frame-time difference for re-syncing is one frame.

21. The system of claim 14, wherein the time base corrector compensates for drift between the incoming PTS/DTS and the re-stamped PTS/DTS.

22. The system of claim 14, wherein the time base corrector shifts the incoming PTS/DTS by a multiple of a frame-time to cause a decoder to drop or repeat a frame.

23. The system of claim 14, wherein the time base corrector manipulates field repetition bits to repeat individual fields.

24. The system of claim 23, wherein manipulating field repetition bits to repeat individual fields comprises adding a field in consecutive B frames wherein the field compensates for PTS/DTS drift.

25. A computer readable medium comprising computer executable instructions embodied thereon for correcting decoder artifacts comprising:
receiving a stream previously stamped with an incoming Presentation Time Stamp (PTS)/Decode Time Stamp (DTS);
re-stamping the incoming PTS/DTS with a predetermined value;
applying a time base corrector; and
providing the stream to a set-top box for display.
